(19) United States
(12) Patent Application Publication
(10) Pub. No.: US 2005/0144040 A1
(43) Pub. Date: Jun. 30, 2005

(54) Method and system for providing customized skin care products at point of sale

(76) Inventor: Charles R. Heehler, Port Orange, FL (US)

Correspondence Address: Elsie C. Turner, Suite 204, 201 Park Place, Altamonte Springs, FL, 32701, US

(21) Appl. No.: 11/007,904

(22) Filed: Dec. 8, 2004

Related U.S. Application Data
(60) Provisional application No. 60/527,646, filed on Dec. 8, 2003.

(51) Int. Cl. G06F 17/60

(52) U.S. Cl. 705/2

(57) ABSTRACT

The invention relates to a business model for providing customized skin care products compounded at the point of sale from preservative- and stabilizer-free super nutrients of proven efficacy as anti-aging substances and as treatment of the cause of unhealthy skin. The invention is intended to rejuvenate the cosmetic departments of fine department stores and upscale boutiques by targeting a clientele characterized by environmental concerns, desire for natural, unadulterated products, a degree of skepticism about the claims of efficacy of older products, and a desire to have the latest and best that science has to offer.

Applicant claims the benefit of his provisional application entitled “Compounding Therapeutic Habitat at the Point-of-Purchase ‘see-that-pop’”, application no. 60/527,646 filed Dec. 8, 2003.

### FIELD OF THE INVENTION

The invention concerns a business system for providing customized skin care products to treat the cause of unhealthy skin, compounded from fresh, preservative-free super nutrients at the point of purchase by the end user.

### BACKGROUND OF THE INVENTION

Skin care products have been known for hundreds of years. Until recently, such products were mainly moisturizers and emollients. Since the 1970's, research and development in the skin care industry has progressed with the discovery of nutrients which can treat the cause of unhealthy skin: anti-oxidants such as alpha lipoic acid and dimethylaminoethanol, vitamins A, C ester and E, defoliants such as retinol and alpha and beta hydroxyl acids, bio-engineered substances which stimulate collagen and elastin syntheses, protein enzyme suppressants, and other anti-aging substances, along with newly discovered vehicles which can penetrate the skin. However, when products incorporating these ingredients are prepared for mass-marketing, they usually incorporate preservatives and stabilizers so that they have a long shelf life. The preservatives and stabilizers tend to degrade the therapeutic efficacy of many of the active ingredients, and to interfere with their absorption. Also, mass production techniques may expose the active ingredients to temperature extremes which can further reduce their effectiveness.

Mass-marketing of skin care products on the internet and in discount stores such as Wal-Mart, Target and K-Mart has drawn business away from the traditional cosmetic departments of upscale department stores. The cosmetic and skin care industry suffers from lack of differentiation from the mass-marketed products and needs to pursue an innovative marketing method to appeal to an upscale clientele that is concerned about pollutants and toxins in their food and consumable items, and that wants the very best that science has to offer in skin care. Importantly, the majority of skin care products that are available from cosmetic manufacturers seek to remedy skin deficiencies or covering up defects, but are not aimed at treating the cause of such deficiencies.

Accordingly it is an object of this invention to provide a business system which operates in upscale boutiques, specialty stores, fine department stores' cosmetic department, or similar environment, and compounds customized skin care products, to treat the cause of unhealthy skin, from fresh, unadulterated super nutrients at the point of purchase.

### SUMMARY OF THE INVENTION

This invention provides a business model for providing customized skin care products compounded at the point of sale from preservative- and stabilizer-free super nutrients of proven efficacy as anti-aging substances and as treatment for the causes of unhealthy skin. The invention is intended to rejuvenate the cosmetic departments of fine department stores and upscale boutiques by targeting a clientele characterized by environmental concerns, desire for natural, unadulterated products, a degree of skepticism about the claims of efficacy of older products, and a desire to have the latest and best that science has to offer.

### DETAILED DESCRIPTION OF THE INVENTION

A prospective end-user of skin care products visits the cosmetic department of a sponsoring store such as Neiman-Marcus, Marshall Fields, Lord and Taylor's or Macy's to obtain one or more skin care products. She finds her way to a counter controlled by a skin care product provider where a technician skilled in determining the individual needs of different end-users advises her on what ingredients are the most suitable for her. She may have a recommendation from a dermatologist as to specific super nutrients that she should be using. She makes a decision to purchase the customized product and it is then compounded in her presence.

1. A business system for providing customized skin care products to an end user at the point of sale comprising:
a skin care product provider entity having a first contractual relationship with at least one end user to provide at least one customized skin care product in response to receipt of consideration from said end user;
a sponsor entity associated with said skin care product provider, said sponsor entity providing business-conducting space to said skin care product provider entity;
said skin care product provider entity having a supply contractual relationship with at least one source of pure, fresh, preservative-free, anti-aging super nutrients of proven therapeutic effectiveness in topical application, and appropriate vehicles for topical delivery of said super nutrients;
said skin care product provider entity having a service contractual relationship with at least one technician skilled in selecting and compounding for an end user a customized combination of at least one said super nutrient with one said appropriate vehicle for topical delivery of said super nutrient, said technician providing compounded product to said skin product provider for delivery to said end user;
means of compounding a selected combination of said super nutrients and said vehicle for topical delivery at point of sale to said end-user.

2. The business system of claim 1 wherein said sponsor entity is a department store having a cosmetic department.

3. The business system of claim 1 wherein said sponsor entity is a specialty store.

4. The business system of claim 1 further comprising a contractual relationship with a source of preservative- and stabilizer-free fragrance, and said means of compounding at point of sale further comprises inclusion of a fragrance to said selected combination.
